(19) United States
(12) Patent Application Publication
(10) Pub. No.: US 2016/0067746 A1
(43) Pub. Date: Mar. 10, 2016

(54) ROBOTIC MATERIALS RECYCLING STATION

(71) Applicant: Konstantinos SOUKOS, Larisa (GR)

(72) Inventor: Konstantinos SOUKOS, Larisa (GR)

(21) Appl. No.: 14/785,718

(22) PCT Filed: Apr. 25, 2014
(86) PCT No.: PCT/GR2014/000030

§ 371 Date: Oct. 20, 2015

(30) Foreign Application Priority Data
May 1, 2013 (GR) 20130100272

(51) Int. Cl. B07C 5/34; G06Q 10/00; G06Q 30/02; B02C 23/08

(52) U.S. Cl. CPC B07C 5/34; B02C 23/08; G06Q 10/30; G06Q 30/0207

(57) ABSTRACT

The robotic materials recycling station is appropriate for use as a concentration station for recycling materials of big volume into limited space, for the thorough and effective <<sorting out at source>> of the disposed materials from every citizen-consumer who is motivated by a rewarding compensation. The main unit of sorting out and treatment (1) of the robotic materials recycling station comprises externally and perimetrically one at least robotic multi-chamber for organic waste treatment (2), equipped with the appropriate devices for the—ecological treatment of the organic—degradable fraction. Also, outside, there is at least one waste disposal gate for the reception of the rest recycling materials and the special waste which through at least one feeding system, are led to its main internal area. Through at least one moving table for material sorting out (5) with material removing exits, material sorting out is achieved. Finally, perimetrically of the robotic station, six at least robotic bins for waste management (patent No. 1005724) for the effective management, after sorting out, of recyclable to compression materials and six at least metallic containers, of appropriate rectangular cross-section (7) for the management of waste that can not be compressed.

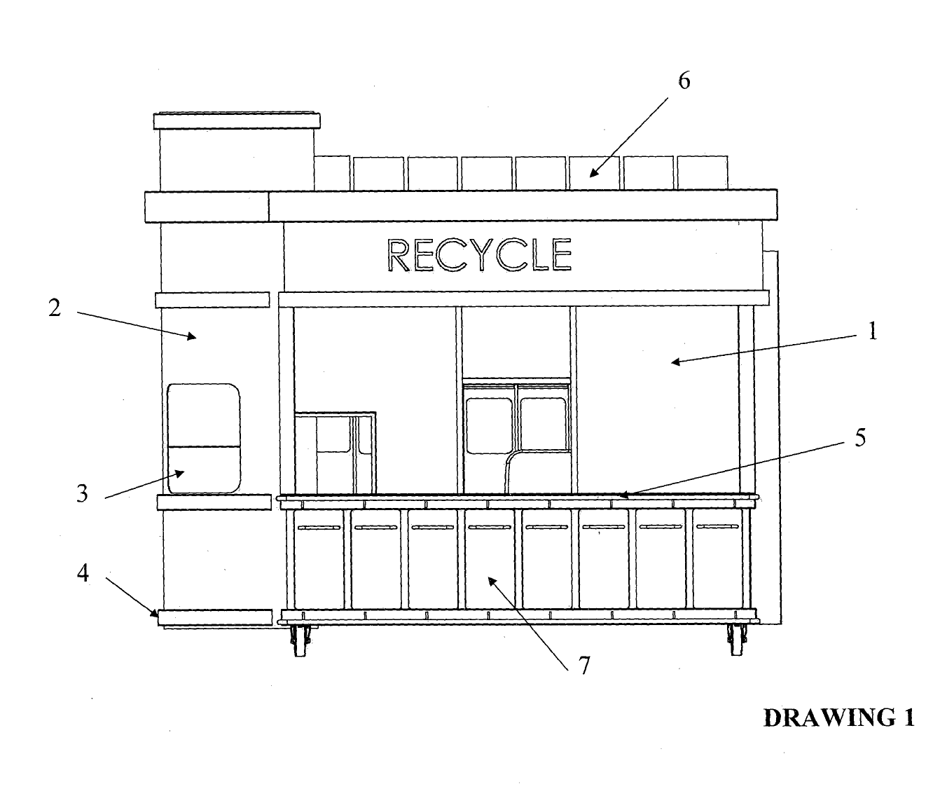

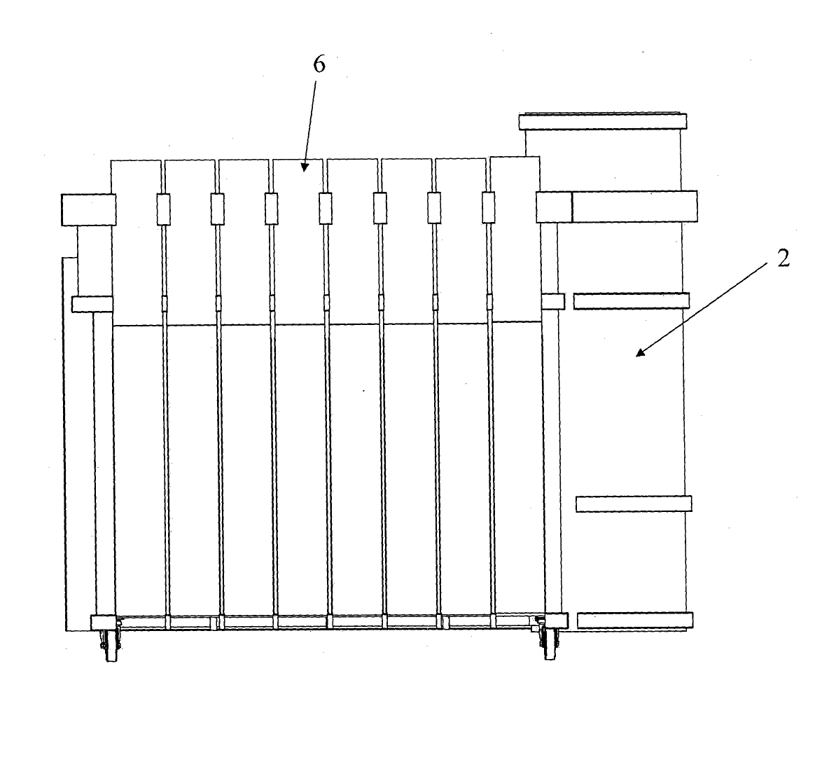

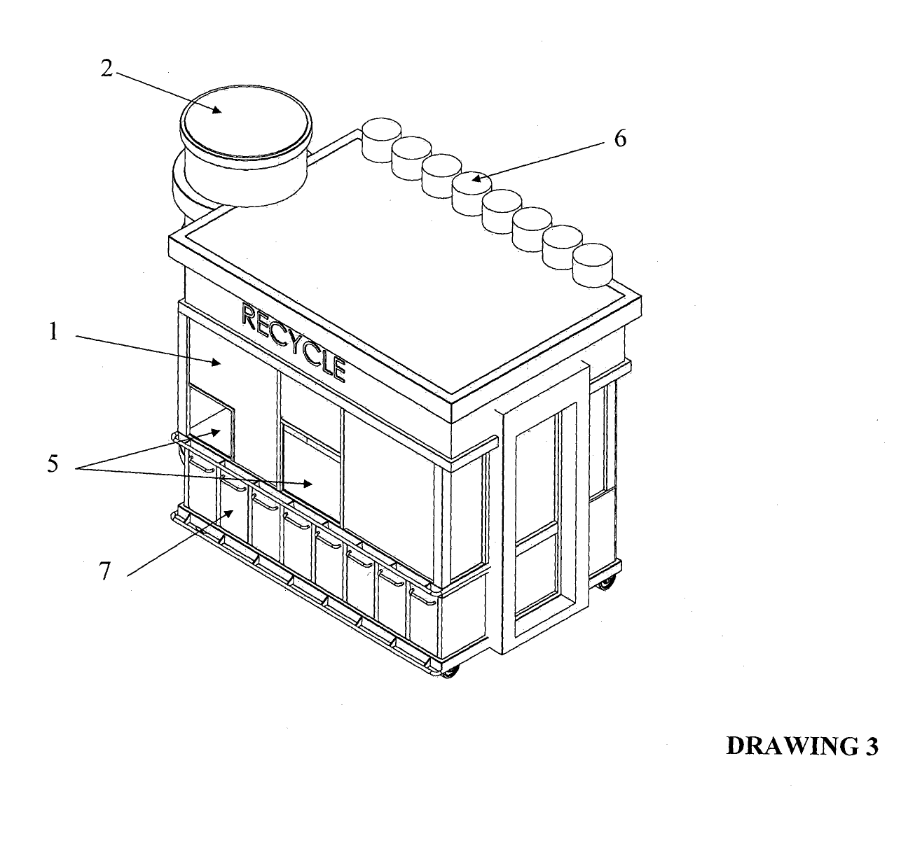

The invention refers to a robotic materials recycling station, which can be placed in numerous places where there is human activity, such as parks, department stores-super markets, gas stations, beaches, tourist attractions, residences, working and entertaining spaces, pedestrian areas etc. The current invention is appropriate for use as a concentration station for recycling materials of big volume into limited space, so as to provide a thorough and effective <<sorting out at source>> of the disposed to materials from every citizen-consumer who is motivated by a rewarding compensation.

The management of municipal solid waste (MSW) constitutes a priority in environmental policy in both EU and national level. The goal accomplishment that stems from the new waste legislation presupposes significant changes as far as the waste management is concerned, so that there can be a more effective resource utilization coming from municipal solid management. Thus the enhancement of environmental protection and of quality of life is achieved.

The fundamental logic is that waste is not a useless burden but precious resource that, if utilized correctly, can provide multiple benefits. This is the reason why the waste rejection in landfills should be the last available choice. On the other hand, the management of waste, no matter how environmentally friendly it is, it consumes energy and resource, resulting in the fact that prevention from production of waste offers more advantages.

Recycling constitutes, undoubtedly, an essential indicator of a country's civilization, as well as a significant proof of environment's protection. In most European countries, recycling and alternative management of disposed material has been successfully applied for several years. Considering that environment's protection is everyone's affair, the success of the alternative treatment depends not only on sensitization, but also on citizens' active participation. The informed and active citizens are the motive lever to materialize the law's target so that the environment will be protected more successfully.

Recycling is the treatment of materials which, even though being destined as waste, retain their value and can be 100% reused, benefiting the environment and the state's economy as well as each citizen's economy, since the waste treatment becomes his affair, offering important financial motives for each citizen. The benefits of recycling are definitely multiple. The major benefits are recited below:
The reduction of the volume and weight of the municipal solid waste that must be collected and transported to landfills, which results in the gradual annulment of landfill.
The saving of first material and energy, which is usually non-renewable (oil, minerals etc).
The creation of new places of work.
The exchange benefits for the directly interested citizen and not the middleman.
The protection of the environment.
The enhancement of quality in our life.
The contribution to culture, since the waste treatment is an indicator of culture.

The waste that can be recycled include:
Paper, for example newspapers and magazines, paper packaging such as cartons
Glass, glass packaging such as glass bottles
Metallic containers such as tins, aluminum cans, iron
Plastic bottles and plastic packaging such as bags
Degradable fraction (organic waste)
Special waste such as batteries, electric and electronic devices, lubricants oils, cooking oils etc.

The 2003 was the watershed year for our country, as far as the recycling area is concerned, since Law 2939/01 obliged all businesses that import, produce and provide packaged products in domestic market to fend for the collection and recycling of their packaging and other products. Therefore, each business has to be connected to a system of alternative treatment, paying in full the special fee based on the product quantities that it sells every year. Therefore, each company is requested to look into the most appropriate solution which will reduce the contribution cost to the Systems of Alternative Treatment and simultaneously gain income by selling the recovered materials.

Also the matter of treatment of biodegradable waste (BW) and biological waste (BW) constitutes a key point for the treatment of solid waste in Greece. The changes that are required for the achievement of the goals of both European and Greek legislation, presuppose a gradual change of waste treatment towards a new direction. This new direction is being signaled by complete solutions in waste treatment, significant enhancement of environment protection and quality of life and gradual approach to a more sustainable management of the solid waste treatment.

The various programs-systems of material recycling that started to be implemented by state-public institutions, take for granted that citizens are willing to carry their packaging-recycling materials to far distances away from home and make the recycling process an everyday matter of choice. In reality though, this practice is unrealistic, due to the fact that everyday rhythms are very quick and each consumer is forced to dedicate specific time in order to fulfill his recycling duty. The disposition for recycling can be increased by the tactic of administering a rewarding motive, which each consumer will use to its' own benefit.

The already existing recycling systems that no longer have the ability to optimize the organic fraction, because of the enormous installation surface they take over, they are being placed in specific-specified spots, which must at the same time combine the easy access of the waste trucks. Moreover, the high costs that are required for the operation and maintenance of these systems, hinder the effort of so many state and private institutions to acquire and operate them.

Simultaneously, all the process methods of organic waste are based on the action and reaction between micro-organisms, it is about biological systems which regardless of the complexity in their technological part—and their cost—they are regulated by some biological principles.

The principle methods that are being used today for the biological waste treatment in household level, is the domestic composting and the domestic anaerobic digestion, with the domestic composting being the most popular between the two techniques. These two techniques, however, present many implementation difficulties such as: the difficulty of the correct implementation by citizens, the production of unwilling odors, the appearance of insects and hazardous micro-organisms for our health, etc.

The preceding concerns in combination with the need to arouse the idea of recycling at the source towards the citizens make the need of a robotic material recycling station imperative, which will provide solutions to all the above problems, combining the important financial benefit towards each citizen.

The current invention refers to a robotic materials recycling station, which consists of:
A main unit of sorting out and treatment of recycling materials (1). This may appear in various shapes and it can be of square or rectangular cross-section etc.
At least one automatic robotic multi-chamber for organic waste treatment (2) which is placed out of the main unit and is equipped with the appropriate devices for the ecological treatment of the organic-degradable fraction. Through the process of the organic fraction into the chamber (2) the complete process and its fast transformation into a low granulometry dried and stable mass, appropriate for multiple uses, is achieved.
At least one waste disposal gate (3) (organic-degradable fraction) placed outside of the automatic robotic multi-chamber for organic waste treatment ( ).
At least one material concentration prechamber of adequacy capacity into the automatic robotic multi-chamber for organic waste treatment (2).
At least one first organic waste fracturing and pushing device and at least a second device for final cutting and stirring, both placed at the bottom section of the material concentration pre-chamber of the automatic robotic multi-chamber for organic waste treatment (2).
At least one exit gate (4) of the material, placed under the second device for final cutting and stirring of the automatic robotic multi-chamber for organic waste treatment (2).
At least one special cleaning and deodorization filter which will extract odour and vapours created by the treatment of the organic fraction, placed on the top of the automatic robotic multi-chamber (2).
At least one waste disposal gate, placed out of the main unit (1) for the reception of the rest recycling materials and the special waste (such as batteries, electric and electronic appliances, lubricants oils, cooking oils etc.)
At least one feeding system for the soft and fast transportation of the rest of the recycling materials and the special waste, into the main unit.
At least one moving table for the sorting out of the recycling materials and special waste (5), with material removing exits, placed inside the main unit (1),
At least six robotic bins for waste management (6) of same height and diameter and of various shape and dimensions, for the effective management of the recycling materials chosen for compression. The robotic bin for waste management constitutes an innovative product which has been patented worldwide with a patent No. 1005724.
At least six metallic containers, of appropriate rectangular cross-section for the management and storage of the special waste (7), placed inside the main unit (1)
A control and operation unit, placed inside the main unit (1), which has all the necessary buttons and the switches of activation, through which all the necessary operations are completed, such as: electronic recording of data and statistical measurements, weighing and receiving the materials, managing and compressing the recycling material packaging and organic waste, automatic point crediting into the magnetic card and/or printing and delivering the rewarding motive receipts for the citizen as well as discount vouchers, sound guidance and informing the consumer, alternation of advertising surfaces, updating and control operation of the robotic bin for waste management (patent No. 1005724), connection-communication of all robotic materials recycling stations, through wireless GSM operation, with a control room, which is situated in a appropriate marked area of a state or a public institution etc.
Systems of automatic point crediting into a special magnetic card or/and the automatic printing and delivering of the rewarding motive receipts for the citizen as well as of discount vouchers, automatic donation of value etc.
At least one space of placement of advertising surfaces of projection.

The designing of this bin, according to the current invention, has taken place taking into consideration the policy of recycling in our country, the tastefulness for its harmonious coexistence with the surrounding space, its functionalism and its possibly better commercial exploitation from each customer. That is to say it is about a SINGLE-GENERAL PURPOSE-INNOVATIVE-ECOLOGICAL STATION of collection and provisional storage of various recyclable material, friendly to the environment, technically and economically feasible, with recyclable materials sorting out at the source which enables their exploitation (recycling, re-use) fact that signals a major saving of resource, for each citizen, for the Municipality and the state.

The present invention aims to create a robotic materials recycling station, according to what has been reported before, which will be used as a station of concentration and storage of a big volume of recyclable materials that comes from residences, shops, working places and in general from all spaces with human activity, thanks to its possibility to manage and compress waste.

A robotic materials recycling station, according to the present invention, presents a lot of advantages.

The present invention presents moreover the advantage that it has a big capacity of storage-compression of the recycled materials, which ranges from 2 m³ to 5 m^{3,} without excluding other sizes.

Consequently the present invention will lead to the reduction of waste mass that is left outside of the bins in pavements, parks, squares, public spaces etc, and consequently in the creation of a pleasant picture of the city, where waste and its collection bins will not constitute hearths of pollution. A usual phenomenon that is observed in pavements and squares deserves to be recorded: mass of cardboards and cartons are left out of the recycling bins because the storage space of the usual bins does not suffice. In the event of rain, these are getting wet resulting in their unsuitability for recycling, and they are finally led to management with the common waste.

It is economical—it has low operation costs. For the application of the present method, neither the expenses of the solid waste transportation to faraway treatment installations are required, nor those for the transportation of the waste to landfills. Such are the expenses of personnel, the purchase of means of transport (such as lorries and crabs), the expenses of the means of cleaning, their maintenance, fuels etc.

Its operation is completely automated. Complete control of all systems operations systems are achieved, as well as the follow-up of the duration and the way of the process via a central electronic system of programmable logicable control (PLC).

It constitutes a friendly technology to the environment. The whole operation of the robotic materials recycling station does not contribute to the production of solid and liquid waste as well as the release of gaseous pollutants in the atmosphere, since it is noiseless (no noise pollution). The present method contributes to the annulment of landfills, but also in the waste incineration. Through the various stages of treatment no residual current is produced, needing territorial disposal because of its inopportunity to exploitation, as it comparatively happens in other known technologies.

Finally, there are enormous profits from the sale of the recovered materials that are collected in the robotic station. Consequently, each private company that is subjected to the frames of obligations of Law 2939/01, with the supply of the robotic materials recycling station it not only accomplishes to decrease the cost of contribution in the Systems of Alternative Management, but also to bring income from the sales of the recovered material. Also the production of dried and constant mass of low granulometry, allows a subsequent use for a lot of aims, rendering it economically exploitable and suitable for multiple applications.

The expenses of each public or private institution for the purchase of this new robotic materials recycling station are decreased when their purchase is financed or subsidized from the start by the advertising companies, which wish the projection of their customers' products in this way. Each robotic station can bring from one up to five different advertising surfaces of projection, with parallel possibility of more than one message on each surface (incorporated system—rolling alternation of advertising surface). In this way a big spectrum of consuming goods is covered and the point of installation of the robotic materials recycling station is functionally reclaimed (e.g. in the exterior space of a supermarket or a department store). Also the robotic materials recycling station can bring luminous advertising projections in request. The readjustment of advertised forms and drawings of the station occurs in an easy way. The available surface for advertising aims ranges up to 2 m² each, without excluding other sizes, depending on the dimensions of the station.

Additionally, it provides the capability of rewarding recycling, offering financial incentives to consumers for recycling. Thereby, a further incentive is providing for more active participation of citizens in recycling process, since after the end of materials discharging, an automatic credit pointing of the special magnetic card is providing and/or delivery to the recycler of rewarding motive receipts which will be translated as discount vouchers offers to acquire various products or even as an automatic donation of the value of the compensation for a social purpose. On the surface of the robotic recycling station, a list of offers or the value of each material will be posted, with labeling of analogous modulations of the compensation (more coupons—receiving of various gifts etc) in case of a massive rejection of a material.

Also, the acquisition of a robotic materials recycling station, contributes also to increasing the success of an environmentally conscious company. Specifically, the reputation acquired by a company (e.g. a supermarket), which has environmental awareness, is an important factor contributing to sales increasing.

Finally, the social role of a robotic materials recycling station is also important, as it contributes to:
Contribution to environment protection and public health.
Compliance with European and Greek legislation for environmental protection and recycling targets.
Urban congestion of the traffic load of waste trucks due to reduction of their route, as mentioned above.
Creation of new jobs.

The present invention offers significant opportunities, which are not provided by any other system of similar function and dynamics. These capabilities refer to:
The choice of “Sorting out at source ” recyclables with ecological and hygienic way
The ecological and rapid treatment of organic waste fraction by converting it into low granulomentry dried and stable mass, suitable for energy purpose
Automatic credit pointing of the special magnetic card and/or delivery print to the recycler of rewarding motive receipts
Automated operation: Through control and operation unit, embodied into the robotic station, all the required functions are achieved.
It has all the advantages and functional capabilities of the robotic waste management bins (Modern station of waste management-patent No. 1005724)
Hygienic way of recyclables collection
Sound information capability and automatic guidance of consumer
Visual information and guidance of consumer.

The present invention can be fully understood with the help of the detailed description which follows, in relation with the attached drawings, in which:

Drawing 1 presents a front view of a robotic materials recycling station, according to the present invention.

Drawing 2 presents a rear view of a robotic materials recycling station, according to the present invention.

Drawing 3 presents a perspective view of a robotic materials recycling station, according to the present invention.

In Drawing 1 the front view of a robotic materials recycling station, according to the present invention, is shown.

The main unit of sorting out and treatment (1) of robotic materials recycling station, includes externally and in the perimeter one, at least, automatic robotic multi-chamber for organic waste treatment (2), equipped with the appropriate devices for the ecological management of organic—degradable fraction and at least one gate for waste disposal for rest recyclable materials and special waste (such as batteries, electrical and electronic devices, lubricating oils, cooking oils, etc.)

In the main interior, the main sorting out unit includes:
at least one feeding system for the smooth and rapid transportation of the rest recyclable materials and special wastes into the main unit (1)
at least one moving recyclable materials and special waste sorting out table (5)
at least one electronic control and operation unit

Finally, in perimeter to the main sorting unit (1) are included at least six robotic bins for Waste Management (6), for the effective management of recyclable materials after sorting out and at least six metal containers of suitable rectangular cross section for the management of special waste (7).

The robotic recycling station is constructed in various dimensions. For example, its height can range between 2-3 m, the length between 2-4 m and the width between 1.5 to 2.5 m.

The recycled materials throwing process inside the robotic recycling station is simple and functional.

When a citizen approach to the robotic recycling station, sees the Automatic robotic multi-chamber for organic waste treatment (2), which has the appropriate materials entry-disposal gate (3) in which the organic waste (degradable fraction) is disposed. Nearby, outside the main unit (1), there is at least one more gate for disposal and reception of other recyclable materials and special wastes. Specifically inside the second gate, are disposed:

Packaging materials and special waste
paper and paper packaging
glass, glass containers, eg glass bottles
metal containers, eg cans, aluminum cans
plastic containers and plastic packaging, eg bag
batteries, glass by color, oils, cooking oils etc.

Beside each material input gate, there is labeling and marking (photo and list), indicating the material entering for recycling, facilitating the citizen.

Optionally there is a sound information capability and informing to consumers (taped instructions) for maximum pointing out-safety of use.

At each input gate, suitable sensors are placed in order to perform electronic recording, identification and weighing of incoming materials. By this way, the separation of recyclables materials by type with ecological and hygienic way and evading the mixture of materials-impurities. It is also possible the points crediting of the special magnetic card and/or printing and delivery to the recycler of rewarding motive receipts, which would translate as discount vouchers with offers to acquire various products or even as an automatic donation of the value of fee for a social purpose.

Then, two ecological treatment and materials management processes take place, simultaneously. The first takes place inside the Automatic robotic multi-chamber for organic waste treatment (2) and the second inside the main unit (1) of robotic materials recycling station.

Specifically:

### A) Operation of Automatic Robotic Multi-Chamber for Organic Waste Treatment (2):

A soon as the citizen places the material for disposal (organic fraction) in the entry of the disposal gate (3), it enters into the Automatic robotic multi-chamber for organic waste treatment (2) by means of material sliding system which is placed inside the inlet gate (3).

Then, the organic waste fraction is directed through flow-temporarily stored and treated—in the materials concentration pre-chamber.

The pre-chamber has sloped side walls for easy materials sliding down and has sufficient capacity for the collection of materials. There on the bottom inside of the metal container, is installed a first waste fracturing and pushing device and a second final cutting and stirring device of incoming materials.

Materials incoming in the pre-chamber (organic fraction) are driven by gravity but also by means of the inclined sidewalls to a first fracturing and pushing device. The device is below against the pre-chamber so that the material to fall onto it. In this device, the incoming organic fraction undergo a primary treatment volume reduction and partial cutting. A primary treatment of the organic fraction is necessary to ensure a smooth flow of operation of this station, but also a high degree of cutting and subsequent homogenization. The whole process is quick, direct and silent.

Preferably, through the first fracturing and pushing device, cutting is performed by rotary motion of a special designed mechanism with multiple cutting elements of high resistance in a specific configuration and series.

Just below the first fracturing and pushing device, a second final cutting and stirring is connected. The connection happens in such a manner that the output of the first device to be connected to the input of the second device so that the passage of materials from top to bottom to take place smoothly and with continuous flow.

Under conditions of continuous operation, in the second final cutting and stirring device, the organic fraction undergo further volume reduction and breaking of its mass in a very low granulometry. At an optimum performance of the present invention, the volume of waste is reduced by 70% and the final size of the waste is approximately from 20 mm and less.

Preferably, the final cutting and stirring device comprises a conic roller with cutting elements placed in the perimeter and in equal distance between themselves and there is also a suitable stirring device (screw). Preferably, the mentioned roller is conical and has straight cutting blades, firmly positioned along its length. The blades have cutting edges and their number must be at least 4 or more.

Through continuous flow of material and simultaneous treatment, the mass dehydration is accomplished simultaneously with the mixing. At the top of the Automatic robotic multi-chamber (2) there is a suitable output that through special piping is connected to at least one special cleaning and deodorization filter. In this filter the cleaning and the deodorizing of unpleasant odors and vapours generated by the treatment process of the organic fraction, is achieved.

Below the second cutting and stirring device there is an exit gate (4) of the material. The exit gate (4) is appropriate configured so that through special piping to allow the discharge of the Automatic robotic multi-chamber (2) and the reception of the dried and low granulometry stable mass, either in bags or through appropriate absorption devices of the competent technical personnel.

### B) Operation of Main Unit (1) of the Robotic Materials Recycling Station:

Since the citizen place the material to rejection (rest recyclable materials and special wastes) at the entrance of the second disposal gate, it enters the interior of the main unit for treatment, sorting out by type, storage and compression (of permissible materials) and disposal to the relevant final receiver.

Specifically through at least one suitable feeding system, takes place the smooth and rapid transportation of rest recyclable materials and special wastes, into the main unit.

Then, the incoming material (rest recyclables and special waste) enters to the sorting out table (5). By the sorting out table, is possible the transfer and exhibition of incoming material, aiming to sorting out according to the type and suitability. To carry out the sorting out process, it is necessary to use appropriate personnel who will perform the sorting out with the help of special tools. It is worth noting that passing waste onto the sorting out table (5) is free from the proportion of biodegradable materials (organic), there are no smelly gaseous, ensuring by this way better working condition for the staff.

Specifically, the material enters through appropriate servomechanisms and is received by an appropriate conveyor belt. The material's movement is rotating, enabling workers of sorting out sector to check the type and suitability.

The conveyor belt of recyclable materials and special wastes sorting out table (5) has at least 2 m length and its movement is achieved through reducer with rounds regulation. There is a possibility of moving right and left and the whole operation is checked via an electrical panel.

Recyclable materials as well as special wastes after sorting out, are removed by workers through material exits (adjustable and pulling up separating gates) placed adjacent to the conveyor belt. Then they are gathered at the bottom end of the sorting out table (5), which through separate piping are driven to storage and management. Specifically:
A) The fraction of recyclables materials to compression is led to at least six robotic waste management bins of equal height and diameter and of various forms and dimensions for the effective management of the sorted out recyclables. The robotic waste management bin is an innovative product which has been worldwide patented with No. 1005724.

The whole operation, storage, compression, evacuation and reception of the sorted out recyclables, is detailed described in worldwide patent No. 1005724.
B) The fraction of special waste (fraction which can not be compressed), is led the six, at least, metal containers, of suitable rectangular cross section for special waste storage—management. Specifically there are robust metal containers, suitable for the reception and storage of special waste. Inside of each container there is a special collection bag for the easy reception of waste.

The material exit gate of each container is accessible from the outer surface of the main unit (1). Once the authorized employee opens the material exit gate, will see the special bag collection and with a slight outward movement removes the bag and then replaces it with a new one. Once the evacuation of each container is completes and after a new special bag collection is placed, the authorized employee closes the output gate to new turnover.

The whole operation of the robotic materials recycling station is monitored and controlled by the control and operation unit, which is placed inside the main unit (1). Through the control and operation unit of modern technology the operator/s can supervise and control each stage of the process and each subsystem. The control and operation unit is equipped optionally with monitors, computers, controllers buttons and activation switches and anything else is necessary for the supervision and control of the process such as: electronic data recording and statistical measurements, weighing and reception of materials, management and treatment of recyclable packaging materials and organic waste, auto points crediting of the special magnetic card and/or printing and delivery to the recycler rewarding motive receipts but also of discount vouchers with offers, sound guidance and information of the consumer, alteration of advertising surfaces, information and operational control of robotic waste management bins (patent No. 1005724), online—communication of each robotic materials recycling station through GSM wireless operation with control room, located in a suitable designated area public or private institution, etc.

1. Automatic materials recycling station for the concentration of recyclable materials of big volume inside a limited space, characterized by the fact that it consists of a main unit of sorting out and treatment of recycling material (1)
which main unit (1) includes externally and perimetrically:
1. At least one automatic robotic multi-chamber for organic waste treatment (2) which is equipped externally
with at least one waste disposal gate of organic—degradable fraction (3), and internally
with at least one organic waste gathering pre-chamber
with at least one organic waste first fracturing and pushing device that precisely underneath it is connected to a second at least device for the final cutting and stirring
at least one exit gate of the material (4) of low granulometry dried and stable mass placed under the second device for the final cutting and stirring
at least one special cleaning and deodorization filter connected via special piping with a suitable exit in its to part
2. At least one waste disposal gate, for the reception of the rest recycling materials and the special waste
3. At least six robotic bins for waste management (6) of same height and diameter and of various shape and dimensions, for the effective management of the recycling materials chosen for compression of the state of the art as described in Patent GR 1005724
4. At least six metallic containers, of appropriate rectangular cross-section for the management and storage of the special waste (7)
5. Systems of automatic point crediting into a special magnetic card or/and the automatic printing and delivering of the rewarding motive receipts for the citizen as well as discount vouchers, automatic donation of value,
6. At least one space for the placement of advertising surfaces of projection which main unit (1) contains internally:
1. At least one feeding system for the efficient and fast transportation of the rest of the recycling materials and the special waste into the main unit (1),
2. At least one moving table for the sorting out of the recycling materials and special waste (5) with material removing exits,
3. A control and operation unit which has all the necessary buttons and the switches of activation, through which all the necessary operations are completed.

2. Automatic materials recycling station, according to claim 1 characterized by the fact that the main unit of sorting out and treatment of recycling materials (1) may take various forms and be of square or rectangular cross-section etc.

3. Automatic materials recycling station, according to claim 1 that is characterized by the fact that material concentration pre-chamber allocates adjacent inclined walls for the easy slipping of materials to the bottom and it is of sufficient capacity for the concentration of materials.

4. Automatic materials recycling station, according to claim 1 that is characterized by the fact that in first organic waste fracturing and pushing device, cutting takes place with the rotary movement of a specially designed mechanism with multiple cutting elements of high resistance in a specific configuration and series.

5. Automatic materials recycling station, according to claim 1, that is characterized by the fact that the second device of final cutting and mixing of the incoming materials consists of a conical roller with cutting elements perimetrically placed and of equal distance from each other while a suitable stirring screw device exists as well, which roller preferably is conical and has straight cutting blades, firmly positioned along its length, having cutting edges and their number must be at least 4 or more.

6. Automatic materials recycling station, according to claim 1, that is characterized by the fact that via the continuous flow of material and the simultaneous treatment there is a simultaneous achievement of both the mixing and the dehydration of mass so that a low granulometry dried and constant mass is produced whilst the volume of the litter is decreased at 70% and the final size of waste is approximately 20 mm and lower.

7. Automatic materials recycling station, according to claim 1, that is characterized by the fact that via at least one waste disposal gate for the reception of the rest recyclable material and special waste the incoming current is led via at least one feeding system to at least one moving table for the sorting out of the recycling materials and special waste (5) with exits for the removal of materials, aiming at the sorting out per species by suitable personnel, the further storage and management.

8. Automatic materials recycling station, according to claim 1, that is characterized by the fact that the conveyor belt of the moving table for the sorting out of the recycling materials and special waste has at least 2 m length and its movement is achieved through reducer with rounds regulation, whereas there is a possibility of moving right and left and the whole operation is checked via an electrical panel.

9. Automatic materials recycling system, according to claim 1, that is characterized by the fact that the rest recyclable materials and special waste after the sorting out by suitable personnel, are removed through the materials exits and through the separate piping they are led to storage and management depending on their type, whilst the fraction which is to be compressed is led to at six robotic bins for waste management of the state of the art as described in Patent GR 1005724, while the fraction which is not able to be compressed is led to storage in at least six metallic containers of suitable rectangular cross-section with a special collection bag in each container for the easy receipt of waste.

10. Automatic materials recycling station, according to claim 1, that is characterized by the fact that in each entrance gate of organic and other recyclable material-special waste, suitable sensors have been placed recording, recognizing and weighing the entering material, separating recyclable material per type and evading the mixture of materials-impurities.

11. Automatic materials recycling station, according to claim 1, that is characterized by the fact that point crediting into special magnetic card is functioning in it, also printing and delivery to the recycler of the receipts of rewarding motive, to be used as discount vouchers for the acquisition of various products as well as for the automatic donation of the value of compensation for a social purpose.
